(19) United States
(12) Patent Application Publication
(10) Pub. No.: US 2013/0115337 A1
(43) Pub. Date: May 9, 2013

(54) Grab-and-Go Food Products and Methods of Making Same

(71) Applicants: Pauline Sheets, Ray, OH (US); Naomi Marie Sundalius, Minneapolis, MN (US); Catherine Proper, Minneapolis, MN (US)

(72) Inventors: Pauline Sheets, Ray, OH (US); Naomi Marie Sundalius, Minneapolis, MN (US); Catherine Proper, Minneapolis, MN (US)

(73) Assignee: Bellisio Foods, Inc., Duluth, MN (US)

(21) Appl. No.: 13/728,046

(22) Filed: Dec. 27, 2012

Related U.S. Application Data
(63) Continuation-in-part of application No. 13/223,404, filed on Sep. 1, 2011.

(51) Int. Cl. A23L 1/00

(52) U.S. Cl. CPC A23L 1/005
USPC 426/92; 426/94; 426/293; 426/291

(57) ABSTRACT

The present disclosure relates to a food product comprising, a filling substrate, prepared using a cooking step that reaches a safe cooking temperature for one or more substrate ingredients; and a batter layer containing starches and surrounding the substrate, with a breading layer applied over the batter layer before cooking, said batter and breading layer being cooked at a temperature sufficient to gelatinize the starches in a crust, wherein the food product is substantially cylindrically shaped, and wherein the food product maintains its shape for point of sale heating and when the food product is held.

### FIELD OF THE INVENTION

The present disclosure relates to novel and advantageous food products, such as filled sticks or bites, which are formulated and packaged for a grab-and-go sales environment, and methods of making the same adapted to a method for heating such products on a roller grill to an eating temperature without degrading the quality of the product.

### BACKGROUND OF THE INVENTION

The convenience store industry is a multi-billion dollar a year industry. Increasingly, convenience stores have become a quick, easy, and relatively cheap source for consumers to purchase grab-and-go food, heated at the point of sale. For example, many convenience stores sell grab-and-go foods such as pizza, prepared sandwiches, hot dogs and/or brats. Hot dogs, brats or other like products may typically be cooked and/or warmed on a hot dog steamer, hot dog broiler, or hot dog roller grill. In the typical roller grill, a plurality of elongate cylindrical rods are mounted in parallel relationship so as to support an object, such as a hot dog, between the rods. The rods are heated to a desired temperature and continuously rotated. As the rods rotate, the hot dogs rotate in an opposite direction in the space created between the rods. As a result of the rotation, the hot dogs remain hot without becoming burned, as would be the case if they were heated on a grill without rotation. Upon removal from the grill, they are typically placed in a bun for the customer to hold.

More modern roller-type grills offer a variety of specialized features. For example, the front rollers may be heated to a first temperature with the back rollers heated to a second higher temperature (or vice versa). The front rollers may then be employed to heat a first food product that requires less heating than a second food product placed on the back rollers. More recently, such roller grill units have been utilized to heat food products other than hot dogs in a vending situation. For example, burrito products have been manufactured to roll on and be heated by a roller grill. Such other products, however, have not been very successful because of the relatively short product life experienced by such products. While hot dogs and sausage type products are traditional and well understood and have dimensions and structures that work well on roller grills and for grab-and-go eating, other food products are a challenge to adapt for roller grills and for grab-and-go consumption.

Another problem with roller grills exists with the products themselves. In the case of non-hot dog products, heating the food product on a roller grill can improve heating uniformity. However, it has also been found that rolling can adversely affect the structural quality of the food product by breaking down the shell and/or drying portions of the food product that may have less innate structural stability or flexibility than, for example, a hot dog. A need exists, therefore, for a variety of grab-and-go food products that may retain their integrity and textural appeal during heating with a roller heating device, for example, that moves the product as it is being heated. A need also exists, for a variety of grab-and-go food products that may retain their integrity during consumption.

Further challenges with such food products can arise during their manufacturing. To provide food safety for a product that is only reheated at the point of sale, the ingredients must be thoroughly cooked during manufacture. This is particularly true when raw or less processed ingredients are used, which may enhance flavor or nutrition, but pose greater food safety problems. Thus, the composition of the food product and the cooking of the ingredients and/or assembled product, must allow at least certain ingredients to reach minimum temperatures needed for food safety, typically, 165° F. With higher temperatures used in the cooking process for an assembled food item, internal steam pressure or contained ingredient expansion can place stress on the outer layer of the food product. This layer is often made of starch and/or breading and is designed to contain all ingredients during cooking, during manufacturing equipment handling and pack out, during transport to points of sale, during heating at the point of sale and any other handling before consumption. Thus, the strength of the container layer must be maintained in all of these situations, and a failure at any point before consumption is bad for the producer, distributor and/or the retailer. Therefore, a need also exists, for a variety of grab-and-go food products that are made at temperatures needed for food safety and that retain their integrity during cooking, manufacturing and all other steps before consumption.

### BRIEF SUMMARY OF THE INVENTION

The present disclosure relates to novel and advantageous food products comprising, a filling substrate and a batter and breading layer surrounding the substrate, wherein the food product is cylindrically shaped, and wherein the food product maintains its shape when the food product is held at one end. The present disclosure also relates to manufacturing processes and food products that consistently have desired shape and dimensions and achieve food safety temperatures during manufacturing and that have a shell or crust layer that keeps its integrity from manufacturing up to consumption.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1A is a cross-sectional view of a food product of the present disclosure, according to one embodiment.

FIG. 1B is a cross-sectional view of food products, on a set of rollers of a roller grill, including a second embodiment.

FIG. 2 shows schematically a process for making a food product of the present disclosure, according to one embodiment.

FIG. 3 shows a further process for making a food product of the present disclosure, according to another embodiment.

FIGS. 4A and 4B show schematically a shaping step in the process for making a food product of the present disclosure.

### DETAILED DESCRIPTION

Background. The present disclosure relates to novel and advantageous food products, such as filled sticks or bites and methods of making the same, which are packaged for a grab-and-go sales environment, to a method for making and cooking such products and to a method for heating such products to an eating temperature without degrading the quality of the product.

The embodiments described herein and the various features and advantages of the embodiments are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to, facilitate an understanding of ways in which the embodiments disclosed herein may be practiced and to further enable those of skill in the art to practice the embodiments described. Accordingly, the examples provided should not be construed as limiting the scope of the claimed invention.

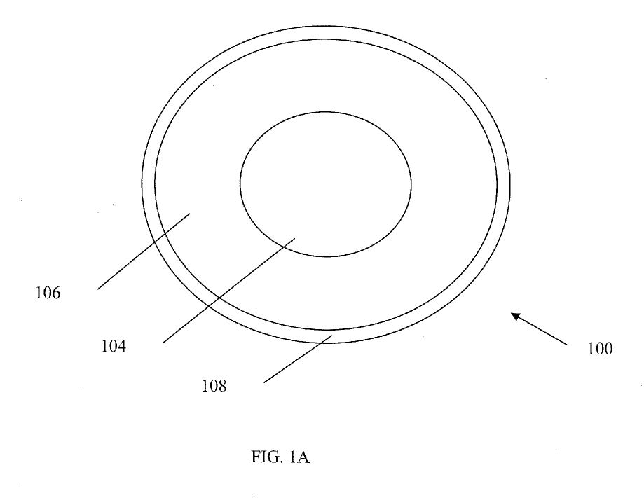

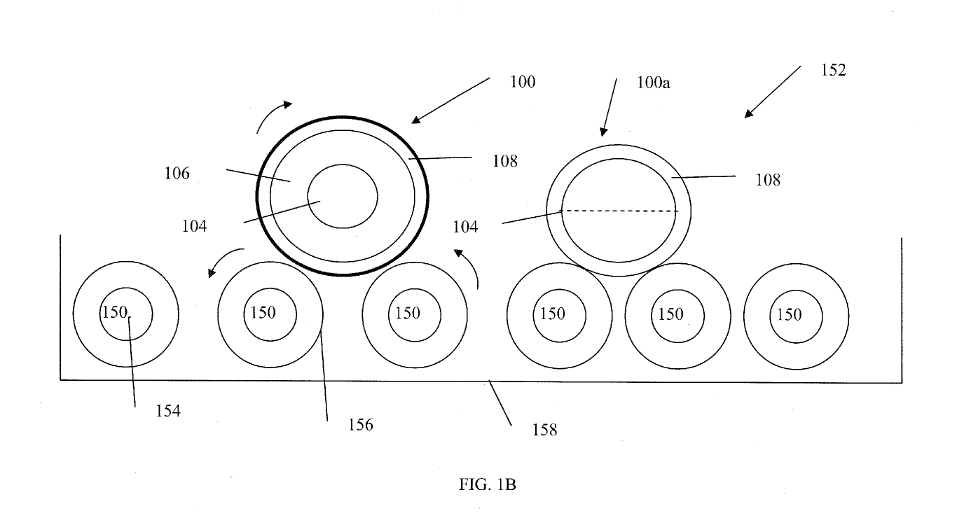

Structure of Substrate. In one embodiment of the present invention, a food product may be comprised of a plurality of layers surrounding a filling. As may be seen in FIG. 1A, moving from the inside of the food product 100 to the outside, a filling 104 may be surrounded by a starch layer 106. This forms a substrate. One or more breading layers 108 may surround the starch layer 106 of the substrate. In one embodiment, the food product 100 may be generally cylindrically shaped, having a similar shape as a hot dog, for example. The food product 100 may have any desired circumference that may depend on what filling 104 may be used, and/or what ingredients may be used for the starch layer 106. In some cases, the food product 100 may have a diameter similar to that of a traditional hotdog, while in other cases, the diameter may be smaller than that of a traditional hotdog. In still other embodiments, the diameter may be greater than, or much greater than that of a traditional hotdog. In some embodiments, for example the diameter may be from about ¾ inch to about 1½ inch. More preferably, the diameter may be from about 1⅛ inch to about 1¼ inch. Similarly, the food product 100 may have any suitable length. For example, in some embodiments, the cylinder length may be shortened to be relatively similar to the diameter, resulting in a substantially spherical food product 100. The diameter of a generally spherical food product 100 may be from about 1½ inches wide to about 1 inch long.

One advantage of some embodiments of the present disclosure is that the food product 100 may have a certain degree of structural stability that may allow the food product 100 to maintain a relatively rigid shape during consumption. In such embodiments, the food product 100 may not generally bend, sag, fold, or otherwise lose its generally cylindrical, straight shape when the food product 100 is raised, moved, or held, for example, at one end, such as when the food product 100 is being eaten. In such embodiments, there may be a practical limitation on how long the food product 100 may be, but generally speaking there is no limitation on the length of the food product 100.

FIG. 1B shows a cross-sectional view of a food product 100 as in FIG. 1A, on a set of rollers of a roller grill 152. As can be seen, the roller grill 152 consists of two or more rollers 150 within a housing 158, each of which rotates on a generally horizontal axis 154 and is heated such that its surface 156 reaches a temperature sufficient for warming or, in some cases, sufficient for surface browning. The rollers are spaced such that food products ranging in diameter from a slim hot dog to a large egg roll or burrito, may be placed between two adjacent rollers without falling down in the gap between them. Rather, the food product rests on and is supported by the sides or tops of two adjacent rollers, such that when at least one of the rollers is driven and the other is free to spin or also driven, friction between the driven roller and the contacting surface of the food product cause the food product to rotate in a direction opposite the rotational direction of the driven roller (see arrows showing rotation). Some adjacent rollers may be more closely or widely spaced than others, to allow for products of differing diameters. In FIG. 1B, rollers to the right show closer spacing and a smaller diameter food product 100a. Although the length of the rollers does not appear in FIG. 1B, it is sufficient to accommodate the length of the supported food products. A benefit of the roller grill for a busy convenience store is that it does not require extensive operator attention, at least as long as the products continue to roll evenly on the rollers.

Ingredients. The filling 104 of the food product 100 may generally be any suitable edible material. In some embodiments, the filling may be selected such that the flavor and taste of the food product 100 is best when cooked and/or eaten hot. Some non-limiting examples of fillings include: buffalo chicken; pizza; sloppy joe mix; hamburger; cheeseburger; fajita; smothered steak; Italian (e.g., pepperoni, salami, ham, cheese); chicken bacon ranch; sausage, peppers and onions; turkey club; barbeque pork; honey mustard chicken; chipotle flavored filling; Philly cheese steak; ham and swiss; chicken pesto; beef, bacon and cheddar; asiago chicken; chili; breakfast skillet (e.g., egg, sausage, cheese, onions, and peppers); loaded potato (e.g., bacon, cheddar, cream cheese and green onions); macaroni and cheese; jalapeno cheddar; or any other desired filling; and/or combination of fillings. The filling may be suitable in some embodiments to be eaten for breakfast, while in other embodiments, the filling may be suitable to be eaten for lunch, dinner, snacks, and/or desert.

The starch layer 106 may surround the filling 104. In some embodiments the starch layer 106 may be the primary functional layer that provides integrity to the food product 100 during the cooking process, as well as the heating, handling, and eating process. In one embodiment, the starch layer 106 may include a blend of starch, gum, and methylcellulose combined with mashed potato. Additives may also be included in some cases, such as additional starch, dairy product(s), seasonings, vitamins, minerals, and/or any other additive that may provide flavor and/or textural attributes, for example. While this layer is referred to as a starch layer 106 herein, it will be understood that in some embodiments starch may not be included in the starch layer 106. The starch layer 106 may include any suitable edible product that may provide integrity to the food product 106, such as, but not limited to: any suitable starch base; masa; cornmeal; short-grain rice; polenta; sticky/sushi rice; small pasta (e.g. acini de pepe, orzo); mashed vegetables (e.g., broccoli, cauliflower, carrot, rutabaga, parsnip, turnip, peas, spinach); arborio rice/risotto; grits; sweet potato/yam; red skin potatoes, or any other potato variety; plantain; couscous; bulgur wheat; quinoa; millet; oatmeal; tapioca; semolina; hushpuppy; granola/muesli; gelatin/jell-o; cream cheese; mousse; pudding; fruit; cheese; or any other suitable ingredient, or combination of ingredients. In addition to the aforementioned ingredients being used in the starch layer 106, in some embodiments, some of the ingredients, or a combination of the ingredients may be used, or may also be used as a filling 104. For example, mashed vegetables, sweet potato/yam, granola/muesli; gelatin/jell-o; cream cheese; mousse; pudding; fruit; and various cheeses, as well as other starch layer ingredients may serve as filling 104.

The breading layer(s) 108 may include a batter and/or breading. For example, in some embodiments, a pre-made batter and/or breading may be used, while in other embodiments any suitable batter and/or breading may be used. The batter and/or breading layer may also comprise spices, nuts, vitamins, minerals, and/or any other particulate ingredients that my add flavor and/or texture. While the food product outer layer makes placement in a bun unnecessary, some products may be formulated to be suitable for placement in a bun.

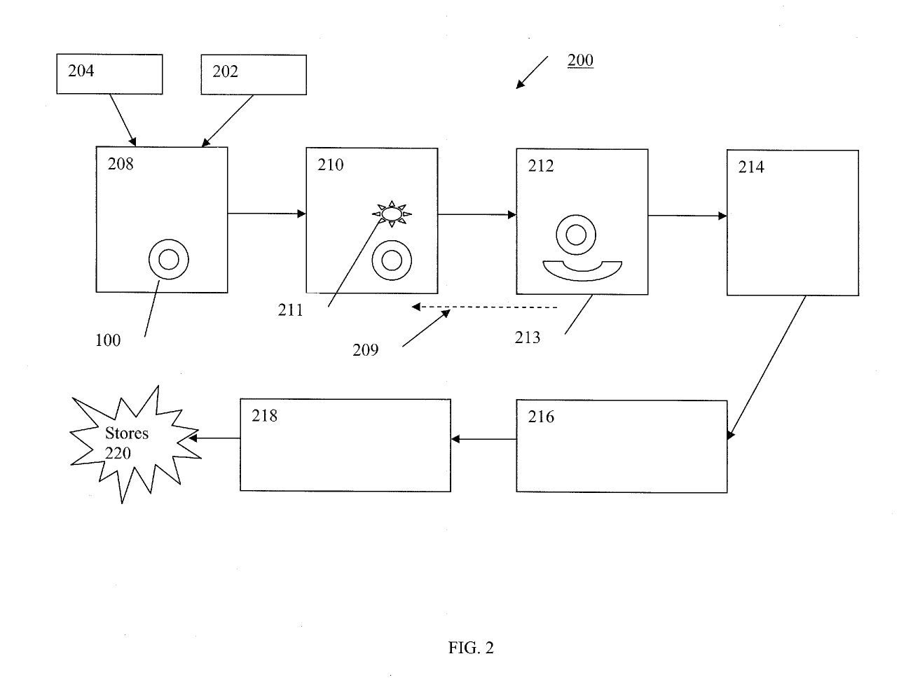

Manufacturing. The food product 100 of the present disclosure in some embodiments may be made by the process 200 shown schematically in FIG. 2. The process 200 may generally be a continuous process in some embodiments, while in other embodiments, the process 200 may occur in steps and/or batches or with some steps using separate batches. The filling 202 and the ingredients comprising the starch layer 204 may be fed to a co-extruder 208, such that after being co-extruded, the filling 202 may be generally encapsulated within the outer starch layer 204. The starch layer may be any suitable thickness. For example, in some embodiments of a food product that is generally cylindrically shaped, the starch layer may have a thickness of from about 0.09 to about 0.19 inch thick. In still other embodiments, the starch layer may have a thickness of from about 0.110 to about 0.150 inch. For embodiments of food products that are generally spherically shaped, the starch layer may have a thickness of from about 0.07 to about 0.2 inch. In still other embodiments, the starch layer of a spherically-shaped food product may have a thickness of from about 0.090 to about 0.150 inch. In still further embodiments, the starch layer 204 is replaced by another material that is not starch, such as a layer that has a higher content of protein.

In another embodiment, the filling and starch layers are not formed by extrusion but rather in two or more layers, which may be planar, half-cylindrical or other shapes. For example, a layer of starch may be first formed, with a layer of filling placed on top. (See 100a in FIG. 1B, where a dotted line indicates two separate layers. For some fillings, that layer may be formed first with the starch layer placed on top. Further, a product may be made with a first starch layer, a filling layer on the first starch layer, and a second starch layer on top of the filling. Layers may be extruded or formed of pieces cut from sheets of filling or starch material that have been prepared as process inputs. A substrate also may be formed with the filling alone or with a blend of filling and the ingredients of a starch or protein layer; in this case components 104 and 106 of FIG. 1A are not separate layers but may be merged into one component as a substrate. Such a substrate may appear as in FIG. 1A, generally cylindrical in form, but with the line between components 104 and 106 removed, so that only filling 104 appears. Such a product is shown in FIG. 1B at 100a.

The co-extruded, extruded or layered product substrate may then proceed to a batter station 210 where the product may be coated and/or sprayed with a wet batter, using a sprayer or other suitable applicator 211. Following the batter station, the product may then be coated with breading at the breading station 212, applied with a sifter-like sprinkler or any suitable applicator 213. The generally dry breading may readily adhere to the wet batter coating the product. In some embodiments, the food product may have a batter/breading thickness of from about 0.08 to about 0.18 inch. In still other embodiments, the food product may have a batter/breading thickness of from about 0.100 to about 0.140 inch. In some embodiments, the product may process through the batter 210 and breading 212 stations one time, while in other embodiments, the product may go through the batter 210 and breading 212 stations two or more times as indicated at arrow 209. It may be advantageous, in some embodiments, for the product to process through the batter 210 and breading 212 stations at least two times to provide a batter-breading layer sufficient to add integrity to the food product. In some embodiments, the batter and breading may be combined.

In one embodiment, the batter for station 210 is made by mixing flour (starch), a protein and leavening to achieve a controlled viscosity. For example suitable batter viscosities may be specified as Zahn cup #4 (8-14 sec @ 50-55° F.). Other viscosities also may be used. In general, batters with greater viscosity build thicker batter layers, but thickness also can be achieved by applying multiple layers. The product to be coated with batter may be predusted with flavor or aroma enhancers. Bread crumbs or other suitable and similar particulate ingredients are applied to a batter coating, followed by another layer of the batter. To this batter layer further bread crumbs and particulate ingredients that enhance aroma and/or flavor and/or visual appeal (e.g., parsley, cracked pepper) are added to complete a twice-battered exterior layer. A further layer of batter followed by further bread crumbs and/or particulate ingredients may added to complete a thrice-battered exterior layer. In general, batters with greater viscosity can accommodate larger particulate material. The breading step has other functions, which will be explained in greater detail below. In particular, the final breading step facilitates the final shaping and dimensioning of the product, to result in a product that has a shape and size compatible with roller grill heating. In addition to providing aroma and/or flavor and/or visual appeal, the particulate matter is also selected to aid product handling for forming. When a battered product is to be formed with pads or rollers, contact with the forming equipment can lead to removal of batter that adheres to the forming equipment, as well as causing batter build-up on the equipment. Use of suitable and sufficient particulate matter reduces or eliminates batter contact with the forming equipment contact surfaces and resultant removal of batter during product forming after batter application.

Following the batter and breading process 210, 212, the product may be processed through a forming (e.g., roller) station 214 that may shape the product into a desired shape, whether that shape is generally cylindrical or spherical. Sizing and smoothness can also be accomplished at this station. Both actions are beneficial, particularly when a product is intended for roller grilling, where sizing can have an important effect on heating time and smoothness aids heat transfer. A properly sized and shaped product will heat in a known time interval (e.g., 20 minutes or 30 minutes) to a target temperature on the roller grill for which it was designed. The target temperature may be required for palatability and to provide another opportunity to maintain food safety, After the product has been suitably shaped in the roller station 214, the product may be cooked in a fryer 216. In some embodiments, a potato base layer may be activated by heat. Accordingly, the cooking temperature in some embodiments may desirably be at least 185 degrees Fahrenheit in order to allow the starch-containing layers to serve as a structural support layer for the food product. The product may be heated a suitable amount of time to ensure that the ingredients are properly cooked. Following heating/cooking, the food product may be packaged and/or frozen at station 218. The frozen food product may then be shipped to stores, restaurants or other consumers or establishments 220.

As noted, for food safety, cooking temperatures of a certain level may need to be achieved for one or more ingredients of a substrate. The necessary temperature or safe cooking temperature varies according to the ingredient materials. Meats have known safe cooking temperatures that are generally higher than those for vegetables. A common safe cooking level used for many ingredients is 165 degrees F. Certain ingredients may be most effectively cooked separately, in a step where temperature is controlled and more easily monitored, and then combined with other ingredients. This permits control to a safe cooking temperature selected for a particular ingredient or a blend that includes a particular ingredient. Thus, it may be desirable to cook a filling ingredient or ingredient blend separately from cooking other ingredients or an outer layer that surrounds the filling. Depending on the cooking method, cooking the outer layer by frying or baking may not result in much heat delivered to a filling. However, in some embodiments, the final frying (or other cooking step) during product manufacture can be designed with a temperature and duration to ensure filling ingredients reach a safe cooking temperature.

In one embodiment, the finished food product may have the following approximate composition by percentage of total weight: starch layer 26%; filling 42%; batter 22%; crumb/seasoning blend 8%; fry oil 2%. The foregoing percentages may be altered in other embodiments without departing from the general spirit and scope of the present disclosure, but the foregoing percentages of ingredients in combination with the foregoing process for making the food product have been shown to result in a food product that may withstand heating and handling without the food product losing its general shape and structural integrity.

The following are examples of food products made according to the above design and manufacturing process or adaptations of it.

### EXAMPLE 1

In one specific embodiment a grillable food product has macaroni and cheese as a filling, with no separate starch layer and the product generally in the form of a cylinder. A suitable product unit weight is in a range of about 2.0-2.5 oz. Suitable product dimensions are: substrate diameter in a range of about ¾″-1″; batter/breader thickness in a range of about 0.140″-0.35″; with the finished product being in a range of about 1″-1.3″. These dimensions have some variability based on raw ingredient variations. Dimensions also may be determined by compatibility with the anticipated roller grill.

An example product composition is:

| Component | Weight (oz.) | Weight % |
|---|---|---|
| Filling (macaroni and cheese) | 1.42 | 61.2 |
| Batter mix | 0.63 | 27.1 |
| Pre-dust | 0.08 | 3.4 |
| Crumb, Breader | 0.17 | 7.3 |
| Oil, Clear fry | 0.02 | 0.9 |
| Formula total unit weight | 2.32 | |

Other weight and percentage specifications may also be used.

In this product, the filling may have a starch/gel/gum mixture instead of a separate starch layer 106. A blend of starch, gum and methylcellulose (to form a gel) may be used in the macaroni and cheese filling ingredients to create some structural integrity and extrudability for the substrate. Additional starch and dairy products may be utilized in the filling to provide flavor and textural attributes.

The coating (batter/breader) system is designed to make a layer that keeps the internal filling in the defined form without the filling blowing out the coating layer from internal heat/steam pressure during product cooking in manufacturing, during roller grill or other point of sale heating and during hot hold time. The layering of the coating system and its cooking in manufacturing creates a shell or crust to maintain internal filling without breakdown. The macaroni and cheese filling formulation is designed with restricted melt cheese to diminish the likelihood of the cheese overheating and exploding out of the product (blowing out) while being cooked for manufacture or later when held heated on a roller grill.

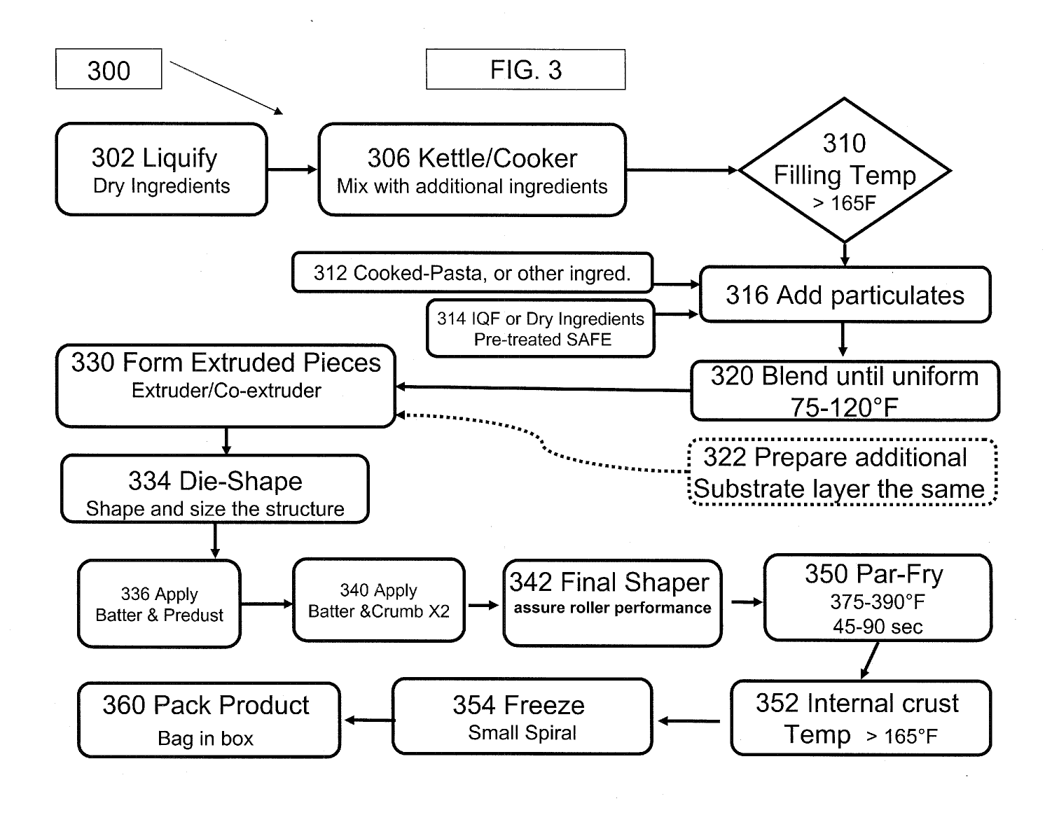

Manufacturing Process for Example 1. FIG. 3 shows one example of a process 300 for manufacturing the grillable macaroni and cheese (or other similar grillable product). In step 302, liquification, dry ingredients such as seasonings, flavors, powders, salt, and sugar are slurried with water and liquids until dissolved. Slurry is transferred to the cooking vessel, e.g., a kettle, for cooking step 306. At step 306, additional ingredients for a filler may be added to the kettle that need heat treatment, such as vegetables and other particulates. At step 310 cooking occurs and a check is done to confirm reaching a safe cooking temperature for the filling ingredients that require cooking to a specific temperature. For example, the check looks for heating to 165° F. minimum (or other suitable temperature, according to filling ingredients). As part of this step, a starch mixture may be included which may be heated with the filling and may include gel, gum or potato flakes or a protein-based fat, to improve extrudability, Many processes will require hotter temperatures (e.g., up to about 185° F.) to develop (gelatinize) any starch or gums that are in the filling. Starch ingredients have been developed that are manipulated to have a selected gelatinization temperature. At step 316, the process calls for adding additional prepared or pre-cooked particulate ingredients, such as cheeses, cooked meat, cooked egg, fruits, etc. Some ingredients to be added may require an additional cooking process step before they are added. For example, an additional step 312 may be used to add cooked pasta or rice; preparing these ingredients may have an additional temperature target to ensure food safety, although for efficiency ingredients requiring a specific food safety temperature may be included in steps 306 and 310, where possible. If there are IQF (individually quick frozen) or dry ingredients, which have undergone a pretreatment to make them safe, at step 314 these are added with other particulates for step 316.

At step 320, the process blends all ingredients until the filling mixture is uniform (e.g., using a bar mixer) and staged to be used in the extruder/forming machine area. For the macaroni and cheese product, this is where pasta and sauce are mixed. In this step 320, the temperature may be lower, e.g., 75° F. to 120° F. If an additional filling ingredient is to be used but kept as a layer separate from the mixture blended at step 320, a separate, optional step 322 is used to prepare the additional filling ingredient for the substrate. The blended filling from step 320, with or without an additional filling ingredient from step 322, is fed to an extruder and formed into extruded pieces at step 330. The forming machine can be an extruder or co-extruder (e.g., equipment from www.vemag.de) or any mechanism that deposits and cuts a piece of substrate of the desired shape, including length. A die shape former may be used at step 334, to achieve the desired shape and size of the structure output by the extruder, to which the outer breading layer(s) will be applied. As noted above, maintaining a consistent and designed shape and dimension is desirable, to make the product perform as expected in later manufacturing steps and also as a finished, delivered, point-of-sale heatable product. The resulting piece may be a single cylindrical log, a double layered log, or a co-extruded log with various lengths. Pieces of various sizes may be called nuggets, bites, sticks, pops, croquettes or puffs.

At step 336, batter with any pre-dust are applied. Then at step 340 batter and a crumb-like particulate (breading) are applied in an action that may be performed once, but is typically performed twice. For both steps, “apply” means to adhere ingredients for a shell/crust on the substrate such as a pre-dust, batter, or breading system by a coating process. Once the applied material is cooked to a shell/crust, it will serve to contain the substrate and deliver the quality attributes needed for a hand-held consumable product through the re-heating and standing process typical of the convenience store serving model. In particular, the relatively thin shell/crust permits non-traditional fillings, such as macaroni and cheese, to be used in grab-and-go foods. If such fillings have enough coherence to be extruded into a substrate, that can be contained in a shell/crust for grab-and-go consumption.

In step 336, the substrate may be dipped into (or otherwise covered with) a batter to coat the substrate evenly and prepare the piece for a pre-dust coating that creates the base of the shell/crust. Then at step 340 the substrate is dipped into (or otherwise covered with) batter followed by breading that is of a specific type and granulation (see examples below) for the product design. After the first battering and breading, the substrate may again pass through batter followed by breading to achieve the exterior layer design of the final structure. In particular, the batter and breading steps build up the thickness of this outer layer that, when cooked, provides a sort of exoskeleton for the food product. Final forming of the still formable roller-grill product structure may be achieved by passing the batter-breaded piece into contact with a layer of pads or rollers at step 342 that shape the product into the final designed length, diameter and form. For example, the product may pass underneath a layer of pads that exert pressure on the outer surfaces of the batter-breaded pieces. In this step, the particulates, which help protect the shaping surfaces from picking up batter, may be integrated into the batter so that less will be lost in later manufacturing steps or by handling and heating the product at point of sale.

Achieving and maintaining the designed food product shape and dimensions are desired. In particular, it is desired that the product (after shell/crust forming) maintains its cylindrical or other shape suitable for roller grilling, and also thereafter when the food product is held by a consumer. As noted, the designed product dimensions can be selected and to some degree controlled at step 342, so that for a roller grill of known characteristics, the product, placed frozen on the grill, will achieve the desired consumption temperature in a known period of time.

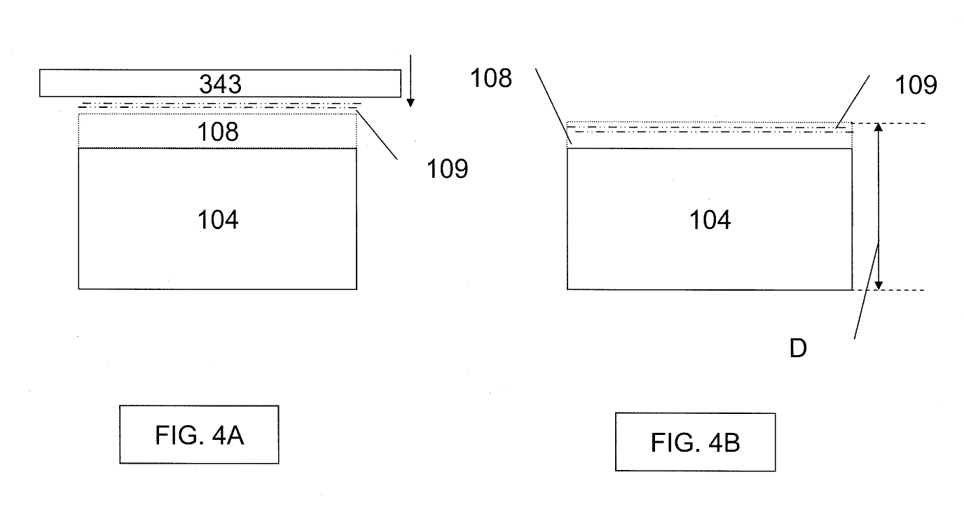

FIGS. 4A and 4B show schematically (and in a magnified scale) the details of a final breading step when shape and dimensions are established with surface-applied pressure for product forming. This is necessary because the extruder may produce pieces that are not a straight as desired (i.e., the longitudinal axis of the substrate may curve) or that may be larger than desired. Batter and breading also may add more size to the product than desired or may make surfaces less smooth than desired. As FIG. 4A shows schematically (only a portion of the substrate 104 is shown here, with one surface battered and breaded; in reality, multiple or all outer surfaces will be battered and breaded, and the surface formed will be a curved portion of a cylindrical surface, not flat) how a final breading step and final shaping may occur. The substrate 104 as shown has received at least one layer of liquid batter 108. It has also received “breading” 109, which may be bread crumbs but can be other particulate matter. (This “breading” 109 is represented by two dot-dash lines that represent the particles that have been sprinkled or otherwise deposited onto the outside of the batter 108.) Plate 343 represents a contact surface that will apply pressure to the breading 109 by moving in the direction of the arrow shown adjacent plate 343. As can be seen in FIG. 4A, the breading 109 helps to keep the plate 343 from having any or much contact with the batter 108, which might adhere to it. The plate 343 will engage and apply pressure to the particulates comprising the breading 109. FIG. 4B shows the result of the pressure applied. The particulates comprising the breading 109 are driven into and thus at least partly integrated with the batter 108. In addition, depending on the content and moldability of the batter 108 and substrate 104, the pressure from contact surface 343 can reduce the dimension D, so that controlled motion of contact surface D can be used to achieve a desired dimension in the direction the arrow shown. With a curved contact surface or with contact surfaces approaching from other directions, other dimensional adjustments needed to achieve desired product dimensions can be performed. Not only is the particulate matter consolidated into the batter and breading layer in preparation for its cooking, but batter 108 disturbance or removal by adherence to contact surface 343 is reduced or eliminated by the layer of breading particulates. These breading particulates not only facilitate manufacturability but can (as discussed below) also be agents for delivering flavor or textures that are desired into the outer shell/crust formed when the batter and breading layer undergoes cooking.

At step 350, the batter-breaded structure is transferred into a heated oil bath and fried at a specific temperature (e.g., in the range of about 375° F. to 390° F.; the specific temperature is based on gelatinizing any gum used in batter) and time (e.g., in the range of about 45 to 90 seconds) to set the shell/crust to the desired texture and color. The time and temperature parameters of this step are controlled so that the internal surface of the crust formed by the batter will reached a selected temperature. For example, the parameters can selected in a testing process, so that the internal crust temperature will consistently reach the 165° F. usually recognized as achieving food safety. At step 354, the fried product is immediately transported to a freezing spiral, to be frozen at a temperature in the range of about 0° F. to 10° F. At step 360, the frozen product is packed according to customer specifications, such as contained in a bag within a box. Packing may be done with compartments or individual unit wrapping, so that the entity preparing the product for final consumption can later easily remove single units for placement on a roller grill (or in another point of sale device) for heating.

The substrate resulting from the process 300 must have a specific firmness to be able to cleanly form up to a 6 inch long, narrow cylindrical shape that will have enough flexibility to travel through the batter/breading process (transfer points) and the final shaping of the piece. This is achieved through incorporating specific food starches, hydrocolloids, and fillers such as potato flakes, polenta, rice, pasta, flours, beans depending on the flavor of the finished product. Addition of protein, in particular, may assist in giving the substrate desired properties for extrusion, as well as for consumer nutrition, This functionality of the substrate must maintain a pleasing texture and eating experience at the point of the final consumption.

The shell/crust for process 300 may consist of a system of batter, pre-dust, and breading combinations, as described. Its job is to contain the substrate by forming a shell or crust around it, with various levels of coarseness, depending on desired design of the product. A pre-dust is typically flour and salt with aroma, flavor, moisture, granulation, and specific absorption characteristics for adhesion of a batter system. A batter mix typically consists of flour, food starch, proteins (corn flour, soy flour or dairy) and leavening. It is mixed with water to achieve the desired amount of “spike” or total pick up of the batter and breading. Batter viscosity helps determine the thickness of applied layers. Batter mix can have a specific aroma, flavor, seasoning, moisture, and viscosity.

A breading as used in process 300 typically consists of bread crumbs, cracker meal, panko crumbs, granola, nut pieces, seeds, with specific granulations to achieve the texture and final structure of the product. It can have other ingredients supplying specific aroma, flavor, texture, color, moisture, seasoning, and particulates. Finally, the breading particulates may be sized and the amount applied adapted to protect the contact surfaces of final shaper 342 from fouling with and removal of still-liquid batter.

Thermal cooking is needed for the final structure to be later grilled and presented hot to the consumer without it being soggy or messy. Thus, the outer shell/crust formed from battering and breading must be heated with a frying process that will drive moisture out of the shell/crust system and gelatinize the starches and proteins, so that a crust or shell forms to contain the filling and withstand the elements of moisture migration during its frozen shelf-life and final cooking process. A limited amount of oil enters the batter/breading during frying. Thus, the cooked batter/breading layer is able to play a structural role for the enclosed substrate.

### EXAMPLE 2

In another specific embodiment the food product has “loaded potato” as a filling contained within a batter/breaded layer, with the product generally in the form of a cylinder. A possible product composition is:

| Component | Weight (oz.) | Weight % |
|---|---|---|
| Filling: Loaded potato | 1.42 | 61.2 |
| Batter mix | 0.63 | 27.1 |
| Pre-dust | 0.08 | 3.4 |
| Crumb, Breader | 0.17 | 7.3 |
| Oil, Clear fry | 0.02 | 0.9 |
| Formula total unit weight | 2.32 | |

Other weight and percentage specifications may also be used.

The manufacturing process for this product may be essentially as shown in FIG. 3. Water, starch and seasonings are liquefied, and this sauce is cooked to 180° F. The remaining ingredients are added, except cheese. This is cooked to 165° F., then IQF cheese is added. The cooked potato mixture is extruded to make the substrate pieces. The substrate undergoes three steps for the batter-breading. First is a pre-dust with a weight pick up of about 0.08 oz, followed by two layers with crumbs, each adding a weight pick up of about 0.4 oz (batter viscosity is Zahn cup #4, 13 sec @ 50-55° F.). In cooking, oil pick-up of about 0.02 oz. occurs with moisture loss of about 0.02 oz.

Again, for Example 2, a suitable product unit weight is in a range of about 2.0-2.5 oz. Suitable product dimensions are: substrate diameter in a range of about ¾″-1″; batter/breader thickness in a range of about 0.15″-0.25″; with the finished product being in a range of about 1.1″-1.25″ These dimensions have some variability based on ingredient variations. Dimensions also may be determined by compatibility with the anticipated roller grill. However, use of the die shape 334 and final shaper 342 (see FIGS. 3, 4A, 4B) can provide a product that will build a batter layer of the designed thickness and achieve final pre-frying dimensions, such that the frozen product will heat predictably within a known time on a point of sale roller grill.

In this product, as in the macaroni and cheese product, the starch/gel/gum mixture of the filling is a functional ingredient utilized to maintain product integrity through the cooking process, with the shell/crust from batter breading and frying adding strength for the point of sale heating, hot hold and eating processes.

One advantage of some embodiments of the present disclosure may be that the food product may be warmed and/or heated on a roller grill that may traditionally be used for cooking and/or warming hotdogs, for example, at convenience stores, bowling alleys, bars, amusement parks, carnivals, parades, etc. Accordingly, the food products of the present disclosure may be sold wherever hotdogs warmed and/or cooked on roller grills may be sold, thereby offering a wider variety of grab-and-go food products to consumers. It will be understood, however, that while some embodiments of food products of the present disclosure may be heated on roller grills, other embodiments may be packaged so that the food product may be heated in the microwave, in the oven, or on the stove top, for example.

Although the present invention has been described with reference to preferred embodiments, persons skilled in the art will recognize that changes may be made in form and detail without departing from the spirit and scope of the invention.

What is claimed is:

1. A food product comprising:
a filling substrate, prepared using a cooking step that reaches a safe cooking temperature for one or more substrate ingredients; and
a batter layer containing starches and surrounding the substrate, with a breading layer applied over the batter layer before cooking, said batter and breading layer being cooked at a temperature sufficient to gelatinize the starches in a crust, wherein the food product is substantially cylindrically shaped, and wherein the food product maintains its shape for point of sale heating and thereafter when the food product is held.

2. The food product of claim 1, wherein the filling substrate comprises a starch layer co-extruded as the substrate outer layer and having a thickness from about 0.09 to about 0.19 inch.

3. The food product of claim 1, wherein the diameter of the food product is from about ¾ inch to about 1½ inch.

4. The food product of claim 1, wherein there are two or more applications of batter and breading forming the batter and breading layer.

5. The food product of claim 4, the batter and breading layer having a thickness from about 0.08 to about 0.18 inch.

6. The food product of claim 1, further comprising fry oil in the batter and breading layer.

7. The food product of claim 1, wherein the food product filling substrate is macaroni and cheese extruded.

8. The food product of claim 7, wherein the food product breading comprises particulates for receiving surface applied pressure to facilitate product forming.

9. The food product of claim 1, wherein the food product is a cylinder, sized for heating on a roller grill.

10. The food product of claim 1, wherein the food product filling substrate is formed by co-extrusion that forms an outer layer at least partially surrounding an inner filling component.

11. A method of making a food product, the method comprising:
forming a filling substrate;
coating the substrate with a wet batter;
coating the substrate with the wet batter with a breading;
shaping the substrate with the batter and breading using a surface that contacts the breading to maintain a cylindrically shaped product and achieve specified dimensions;
cooking the resulting batter-breaded substrate in a fryer; and
freezing the resulting food product.

12. The method of claim 11, further comprising coating the batter-breaded coated product with another layer of wet batter and coating the wet batter with another layer of breading before cooking in the fryer.

13. The method of claim 12, wherein the batter and breading contain starches and proteins and the step of cooking comprises frying at a temperature sufficient to gelatinize the starches and/or proteins so that an exterior crust forms on the product.

14. The method of claim 12, wherein the batter and breading is cooked in the fryer at a temperature of at least about 185° F.

15. The method of claim 11, further comprising packaging the food product for later heating on a roller grill.

16. The method of claim 11, wherein the filling includes one or more of a meat product or a cheese product.

17. The method of claim 11, wherein the step of forming a filling substrate comprises co-extrusion that forms an outer layer at least partially surrounding an inner filling component.

18. A food product for warming on a roller grill, the food product comprising:
a filling substrate, prepared using a cooking step that reaches a safe cooking temperature for one or more ingredients; and
a batter layer, said layer containing starches and surrounding the substrate, a breading layer applied over the batter layer before cooking to receive surface applied pressure for product forming, the batter and breading layer being cooked at a temperature sufficient to gelatinize the starches so that a crust forms,
wherein the food product is substantially cylindrically shaped, and wherein the food product maintains its shape for point of sale heating and thereafter when the food product is held.

19. The food product of claim 18, wherein the filling includes one or more ingredients chosen from: potato, a cheese product, a meat product, a vegetable or combinations of the foregoing.

20. The food product of claim 18, wherein the batter and breading layer contains starches and proteins and the step of cooking comprises frying at a temperature sufficient to gelatinize the starches and proteins so that a exterior crust forms on the product.

21. The food product of claim 18 wherein there are two or more applications of batter and breading forming the batter and breading layer.

22. The food product of claim 18, the batter and breading layer having a thickness from about 0.08 to about 0.18 inch.

23. The food product of claim 18, wherein the filling substrate is extruded or co-extruded.
